(19) United States
(12) Patent Application Publication
(10) Pub. No.: US 2010/0285284 A1
(43) Pub. Date: Nov. 11, 2010

(54) INORGANIC PHOSPHORESCENT ARTICLE AND METHOD FOR MAKING SAME

(76) Inventor: Brian C. LaCourse, Pepperell, MA (US)

Correspondence Address: LumaCera Innovative Materials Inc., 83 East Streeet, Pepperell, MA, 01463-1302, US

(21) Appl. No.: 12/777,216

(22) Filed: May 10, 2010

Related U.S. Application Data
(60) Provisional application No. 61/177,097, filed on May 11, 2009.

(51) Int. Cl. B32B 3/10; C09K 11/80; C09K 11/54; C09K 11/56; B32B 9/00

(52) U.S. Cl. 428/195.1; 252/301.4 R; 252/301.6 S; 428/690

(57) ABSTRACT

An inorganic phosphorescent article having a formed phosphorescent layer where the phosphorescent layer is not mixed with a frit and the majority of the layer comprises photoluminescent phosphors comprising rare earth doped alkaline earth aluminates, rare earth doped alkaline earth silicates, zinc sulfide doped with copper or mixtures thereof. The phosphorescent articles of the present invention may be formed as tile bodies and fired at high temperatures between 1000C and 1600C providing durable ceramic and porcelain tiles suitable for use in emergency lighting flooring systems, aqueous environments such as pools and spas, and outdoor pathway lighting.

This application claims the benefit of U.S. provisional patent application Ser. No. 61/177,097 filed on May 11, 2009.

### BACKGROUND OF THE INVENTION

Buildings and subway stations display emergency and exit signs in order to direct people to a safe location in the event of a fire, natural disaster, or other event. In many cases electrical power is lost during such an event. If the building goes dark, another means is required to illuminate the emergency signage.

One solution for such a problem is the use of photoluminescent materials. Photo luminescent materials can absorb light from the sun or from man made light sources. The light energy is then released, at a different wavelength. Some photo luminescent materials release the absorbed light energy at a slow rate, such as over several hours. The slow release of absorbed light energy is referred to as phosphorescence. Therefore, photoluminescent materials displaying phosphorescence can be charged with light from the sun or an artificial light source and then release the absorbed light energy in the dark over several hours providing illumination of emergency signage.

Some examples of inorganic photoluminescent compositions include alkaline earth aluminates doped with rare earths, such as strontium aluminate, and zinc sulfide doped with copper. These inorganic photoluminescent materials are commercially available in a powder form under the brand name Lumilux® (Honeywell US, Morristown, N.J.).

Conventional use of these inorganic photoluminescent material powders involves the dispersion of the powder into an organic or plastic matrix. This plastic matrix may then be formed using conventional plastics processing techniques such as compression molding, casting, extrusion and injection molding to create useful glow in the dark articles such as emergency signs, safety tape and toys. While numerous uses for this type of organic matrix photoluminescent article can be found there are important potential uses for photoluminescent articles for which this organic plastic matrix is poorly suited. The general use limitations associated with plastics in that they typically degrade when used in prolonged or sustained ultra violet (UV) radiation environments, degrade upon high temperature exposure and have poor wear resistance when subjected to an abrasive environment makes the use of organic plastic matrix photoluminescent articles unsuitable for applications such as emergency signage where fire is involved, outdoor tile subject to intense UV and floor tiling subject to high foot traffic.

The highly desirous potential benefits of using photoluminescent materials in floor tile are described in U.S. Pat. No. 6,841,785 to Nolt, entitled, “Photoluminescent Floor Tile”. This patent discloses a photoluminescent floor tile system in which conventional inorganic photoluminescent phosphors are incorporated within a tile body containing limestone or clay. This construction requires that a substantial amount of photoluminescent material be added to the tile body to produce the desired phosphorescent properties. As an alternate embodiment, Nolt discloses a tile body having a wear layer of non-transparent inorganic material incorporating a resinous thermoplastic binder and photoluminescent material adjacent to the top surface of the wear layer. While the proposed floor tiles disclosed in the patent to Nolt are an improvement over previous photoluminescent tiles, these tiles are still subject to high cost (due to the amount of photoluminescent material incorporated in the tile body), high wear rates (related to the unfired or conventionally processed tile body) resulting in additional frequent replacement costs and UV degradation due to the thermoplastic resinous binder which incorporates the photoluminescent material.

Another example of photoluminescent tile is described in U.S. Pat. No. 7,297,416 to Lee, entitled, “Photoluminescent Tile and Method for Fabricating the Same”. This patent discloses a photoluminescent tile construction in which a tile body has been machined or grooved to create a recess in the tile surface or body and a photoluminescent glaze powder (photoluminescent phosphor expressed by MAl₂O₄ (M: metal) in 50-90 wt % mixed with glass frit in 10-50 wt %) is used to fill the recessed areas, covered with a protective frit layer and then conventionally fired at a temperature between 500 C and 1200 C. The photoluminescent glaze powder when fired at temperatures up to about 1050 C as provided in the examples produces a glassy mixture which is contained within the recessed areas. This method of producing a tile with machined or formed recessed areas and subsequently filling with a photoluminescent glaze is an improvement over previous photoluminescent tiles employing thermoplastic resins however this type of processing is very expensive. As an alternate embodiment, Lee discloses a photoluminescent tile in which a tile body having no machined recesses or grooves has a photoluminescent glaze powder placed on the surface of the tile in a pattern, a wear glaze covering the patterned photoluminescent glaze and firing a temperature between 500 C and 1200 C. While this method of producing a tile is lower cost than the machined groove method, the flowing nature of the photoluminescent glaze powder while firing can result in a distorted photoluminescent pattern. Additionally, conventional firing of these articles above 1050 C for an extended period of time, typically result in a degradation of photoluminescent properties.

### SUMMARY OF THE INVENTION

The present invention is directed towards a phosphorescent article and a method of producing said phosphorescent article having a formed layer made up of essentially inorganic photoluminescent phosphor comprising a rare earth doped alkaline earth aluminate, rare earth doped alkaline silicate or zinc sulfide doped with copper

There are numerous inorganic rare earth doped alkaline earth aluminate photoluminescent phosphors suitable for use in a phosphorescent article according to embodiments of the present invention. Some of these rare earth doped alkaline earth aluminates include formulations of strontium aluminate (SrAl₂O₄), calcium aluminate (CaAl₂O₄) and barium aluminate (BaAl₂O₄) or mixed combination. Photoluminescent phosphors of aluminates such as these may be doped with rare earth elements such as europium (Eu), cerium (Ce), praseodymium (Pr), neodymium (Nd), samarium (Sm), dysprosium (Dy), holomiun (Ho), erbium (Er), thulium, (Tm), ytterbium (Yb), lutetium (Lu) or combinations thereof. Suitable inorganic photoluminescent phosphor materials are commercially available in a powder form under the brand names Lumilux®, produced by Honeywell US, or LumiNova® produced by Stone Nemoto Co., Ltd.

In accordance with an aspect of the present invention there is provided a method for producing a phosphorescent article comprising the steps of providing a photoluminescent phosphor comprising a rare earth doped alkaline earth aluminates, forming said photoluminescent phosphor into a shape using conventional ceramic processing techniques, firing said formed shape at a temperature between 1000 C and 1600 C in a controlled atmosphere.

Conventional ceramic processing techniques are used form the photoluminescent phosphor powders into a layer or shape. These techniques include pressing, slip casting, tape casting, injection molding, screen printing, etc. Organic processing aids, such as binders, dispersants, defoamers, etc may be used during the forming step to assist in the process. During the firing step these organic processing aids are volatilized and completely removed from the finished phosphorescent article. Firing takes place in a furnace or kiln capable of maintaining sustained temperatures of 1600 C and providing a controlled atmosphere. The firing can be carried out in air, an inert atmosphere such as Argon, or in a reducing atmosphere such as an atmosphere containing some portion of hydrogen. The type of atmosphere suitable for a phosphorescent article of the present invention is determined by the particular photoluminescent phosphor and preservation of the valence state of dopants within the phosphor.

In accordance with another aspect of the present invention there is provided a phosphorescent article having a composite structure. The composite structure includes a substrate layer bonded to a phosphorescent layer where the phosphorescent layer comprises greater than 90% by volume of photoluminescent phosphors. A phosphorescent article according to this aspect of the present invention may be formed providing a substrate and using ceramic processing techniques to apply the phosphorescent layer then firing the composite structure at a temperature between 1000 C. and 1600 C.

In accordance with yet another aspect of the present invention there is provided a phosphorescent article having a composite structure with at least three layers. These layers include a substrate layer, a wear layer and a phosphorescent layer positioned between and bonded to the substrate and wear layers. The composition of the phosphorescent layer is such that the photoluminescent phosphor makes up a substantial majority of the layer and is not mixed with a frit. Each layer can be formed separately and then stacked to form the composite structure, or the each layer can be formed by coating a previously formed layer. Each layer can be formed from a powder using conventional ceramic powder processing techniques. Layers may be coated onto previously formed layers by spraying, brushing, dipping, or other coating method. Once the layers have been formed, the composite structure can be fired to temperatures between 500 C and 1600 C for up to several hours. All of the layers can be fired together at one time, or the forming and firing can be divided into several steps were some layers are fired before forming subsequent layers.

In accordance with still another aspect of the present invention there is provided a phosphorescent article having a composite structure including a substrate layer, a reflective layer bonded to the substrate layer and a phosphorescent layer bonded to the reflective layer. The phosphorescent layer comprises photoluminescent phosphor. An optional wear layer may be bonded to the phosphorescent layer. The reflective layer is designed to reflect light emitted from the phosphorescent layer back through the phosphorescent layer providing a more pronounced and sustained phosphorescent effect. Suitable compositions for the reflective layer are those that reflect the wavelength of emitted light from a particular photoluminescent phosphor and include materials such as alumina (Al₂O₃), titania (TiO₂) and mixtures thereof. Each layer can be formed separately and then stacked to form the composite structure, or the each layer can be formed by coating a previously formed layer. Each layer can be formed from a powder using conventional ceramic powder processing techniques. Layers may be coated onto previously formed layers by spraying, brushing, dipping, or other coating method. Once the layers have been formed, the composite structure can be fired to temperatures between 500 C and 1600 C for up to several hours. All of the layers can be fired together at one time, or the forming and firing can be divided into several steps were some layers are fired before forming subsequent layers.

Suitable wear layers for any of the aforementioned embodiments may include low or high fire glazes. The wear layer may include decorative patterns or colorants. Alternatively decorative layers may be added to the composite structure to provide improved aesthetic properties.

In accordance with still yet another aspect of the present invention there is provided a phosphorescent article where the phosphorescent layer takes the form of various indicia, graphics, designs or lettering to convey concepts to those who may view them. For example, the shaped phosphorescent phosphor may be formed into an arrow to convey a directional path for someone to follow in the case of emergency signage. A schematic design of a person taking a step may indicate a nearby flight of stairs. Wording may be formed such as “EXIT” denoting an exit location in the case of fire.

The phosphorescent articles of the present invention are well suited for creating dense, highly wear resistant, UV stable, high temperature use tiles for flooring, walls, pools, spas, outdoor pathway lighting, general low level lighting, backlighting of indoor or outdoor signage and other decorative uses. Additionally, photoluminescent articles of the present invention may be combined with other technologies for use in displays, electroluminescent devices and scintillation technology.

These aspects of the invention and the advantages thereof will be more clearly understated from the following description and drawings of preferred embodiments of the present invention:

### BRIEF DESCRIPTION OF THE DRAWINGS

FIG. 1 is a partially enlarged view of a photoluminescent article according to an embodiment of the present invention;

FIG. 2 is a partially sectioned view of a photoluminescent article according to another embodiment of the present invention;

FIG. 3 is a partially sectioned view of a photoluminescent article according to still another embodiment of the present invention;

FIG. 4 is a partially sectioned view of a photoluminescent article according to yet another embodiment of the present invention;

FIG. 5 is a diagram illustrating a method of forming a photoluminescent tile according to an embodiment of the present invention;

FIG. 6 is a diagram illustrating a method of forming a photoluminescent tile according to another embodiment of the present invention;

### DETAILED DESCRIPTION OF THE INVENTION

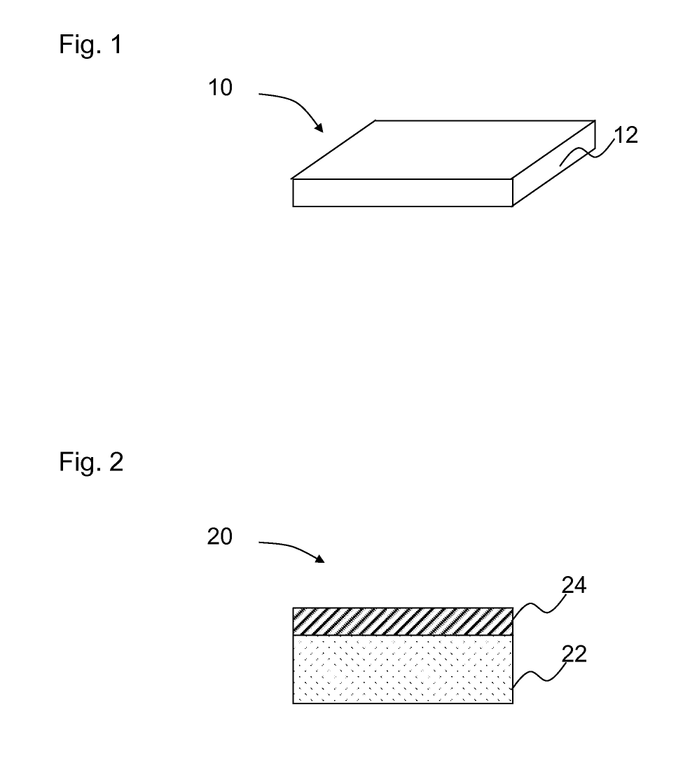

Generally, an inorganic phosphorescent article of the present invention may be used in any location where it is desirous to have low level lighting such as a part of an emergency lighting system. FIG. 1 generally illustrates an inorganic phosphorescent article 10 of the present invention which includes a formed phosphorescent layer 12. Phosphorescent layer 12 is preferably made where the majority of the layer 12 comprises photoluminescent phosphors powders of rare earth doped alkaline earth aluminates or rare earth doped alkaline earth silicates or zinc sulfide doped with copper or combinations thereof. Some of these rare earth doped alkaline earth aluminates include formulations of strontium aluminate (SrAl₂O₄), calcium aluminate (CaAl₂O₄) and barium aluminate (BaAl₂O₄) or mixed combination. Of the aluminates, strontium aluminate is preferred. Dopants for the aforementioned aluminate formulations include rare earth elements such as europium (Eu), cerium (Ce), praseodymium (Pr), neodymium (Nd), samarium (Sm), dysprosium (Dy), holomiun (Ho), erbium (Er), thulium, (Tm), ytterbium (Yb), lutetium (Lu) or combinations thereof. Suitable commercially available photoluminescent phosphors powders are supplied under the trade name of Lumilux® by Honeywell US. Conventional ceramic powder processing techniques may be used to form phosphorescent layer 12 into a desired shape. These techniques include pressing, slip casting, tape casting, injection molding, screen printing, etc. Organic processing aids, such as binders, dispersants, defoamers, etc may be used during forming to assist in the process of forming. Phosphorescent layer 12 is then fired in a furnace at temperatures ranging between 1000 C. and 1600 C preferably in a controlled atmosphere. During the firing process the organic processing aids are volatilized and completely removed from the finished phosphorescent article 10. The controlled atmosphere during the firing process may be provided by supplying air, or creating an inert atmosphere using Argon or a reducing atmosphere using Hydrogen. The controlled atmosphere during the firing process ensures that the valence state of the dopants within the photoluminescent phosphor can be maintained in their proper state to allow optimal phosphorescent properties of phosphorescent article 10.

FIG. 2 illustrates a cross sectioned view of an alternate embodiment of the present invention where a phosphorescent article 20 includes a substrate 22 bonded to a phosphorescent layer 24. This type of construction for phosphorescent article 20 allows a thin phosphorescent layer 24 to be supported by substrate 22. Substrate 22 is typically a ceramic composition formed by conventional ceramic processing techniques. Phosphorescent layer 24 contains no frit and is substantially formed of photoluminescent phosphor powders. Photoluminescent phosphor powders make up greater than 90% by weight of phosphorescent layer 24. Phosphorescent layer 24 may be formed onto the surface of substrate 22 as a thin layer using conventional ceramic powder processing techniques such a tape casting, slip casting or silk screening. Alternatively, phosphorescent layer 24 may be formed into a thin sheet separately and then stacked on substrate 22. Photoluminescent article 20 may then be fired in a furnace a temperature between 500 C and 1600 C in a controlled atmosphere. The preferred firing temperature phosphorescent layer 24 is between 1000 C and 1600 C to form a dense sintered layer adherent to substrate 22.

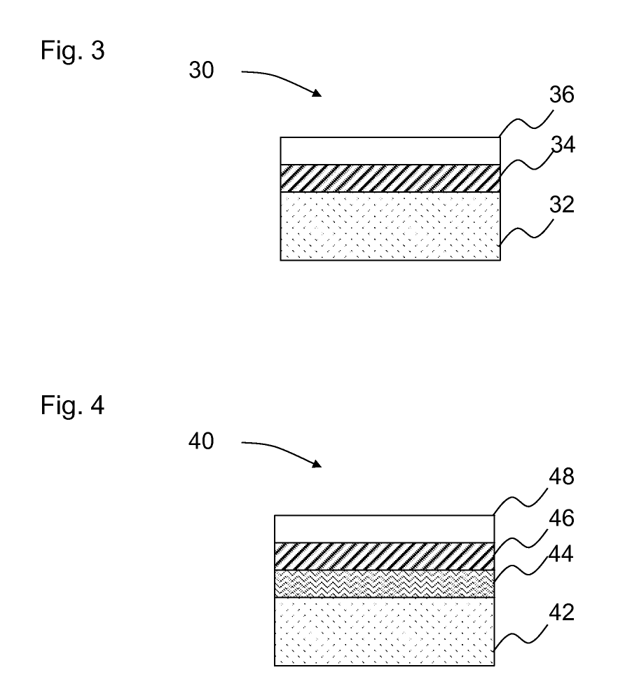

FIGS. 3 and 4 illustrate additional alternate embodiments of phosphorescent articles of the present invention having composite structures. FIG. 3 shows an enlarged cross sectioned view of phosphorescent article 30 having a substrate 32, a phosphorescent layer 34 and a wear layer 36 where the phosphorescent layer 34 is disposed between the substrate 32 and wear layer 36. Substrate 32 is typically a ceramic composition formed by conventional ceramic processing techniques. Phosphorescent layer 34 preferably has a composition that does not contain a frit and is substantially formed of photoluminescent phosphor. Phosphorescent layer 34 may be formed onto the surface of substrate 32 as a layer using conventional ceramic powder processing techniques such a tape casting, slip casting or silk screening. Wear layer 36 may be a frit containing layer and is intended to provide desirable surface properties for the fired phosphorescent article 30. These desirable surface properties may include matte, gloss, textured, anti-slip, decorative, colorants and abrasion resistance finishes or combinations thereof. The wear layer 36 may be formed onto the surface of phosphorescent layer 34. Alternatively, phosphorescent layer 34 and wear layer 36 may be formed into sheets separately and then stacked on substrate 32. The layers of phosphorescent article 30 may then be co-fired in a furnace at a temperature between 500 C and 1600 C in a controlled atmosphere.

FIG. 4 shows an enlarged cross sectioned view of phosphorescent article 40 having a substrate 42, a reflective layer 44, a phosphorescent layer 46 and a wear layer 48 where phosphorescent layer 46 is disposed between reflective layer 44 and wear layer 48. Substrate 42 is typically a ceramic composition formed by conventional ceramic processing techniques. Reflective layer 44 is designed to reflect light emitted from the phosphorescent layer 46 back through the phosphorescent layer providing a more pronounced and sustained phosphorescent effect. Suitable compositions for the reflective layer are those that reflect the wavelength of emitted light from a particular photoluminescent phosphor and include materials such as alumina (Al₂O₃), titania (TiO₂) and mixtures thereof. Reflective layer 44 may be formed onto the surface of substrate 42 using conventional ceramic powder processing techniques. Phosphorescent layer 46 preferably has a composition that does not contain a frit and the majority of the layer is formed of photoluminescent phosphor. Phosphorescent layer 46 may be formed onto the surface of reflective layer 44 as a layer using conventional ceramic powder processing techniques such a tape casting, slip casting or silk screening. Wear layer 48 may be a frit containing layer and is intended to provide desirable surface properties for the fired phosphorescent article 40 and is preferably transparent. These desirable surface properties may include matte, gloss, textured, anti-slip, decorative, colorants and abrasion resistance finishes or combinations thereof. Alternatively, reflective layer 44, phosphorescent layer 46 and wear layer 48 may be formed into sheets separately and then stacked on substrate 42. The layers of phosphorescent article 40 may then be co-fired in a furnace at a temperature between 500 C and 1600 C in a controlled atmosphere.

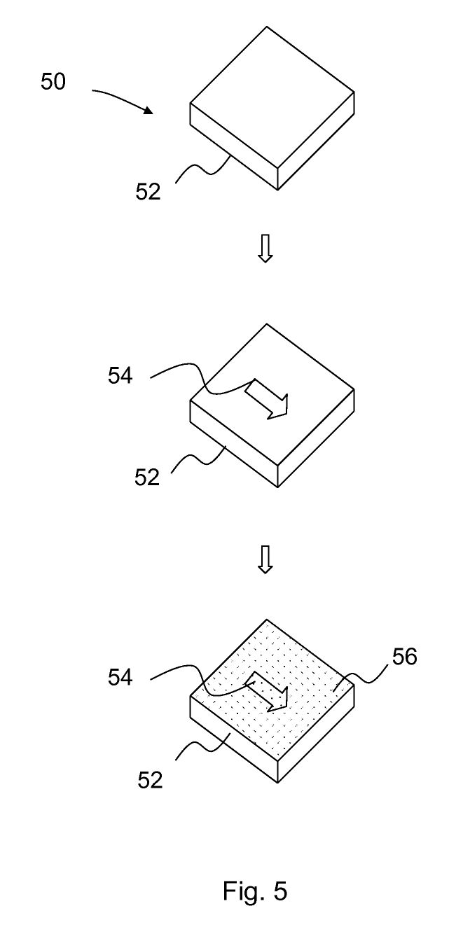

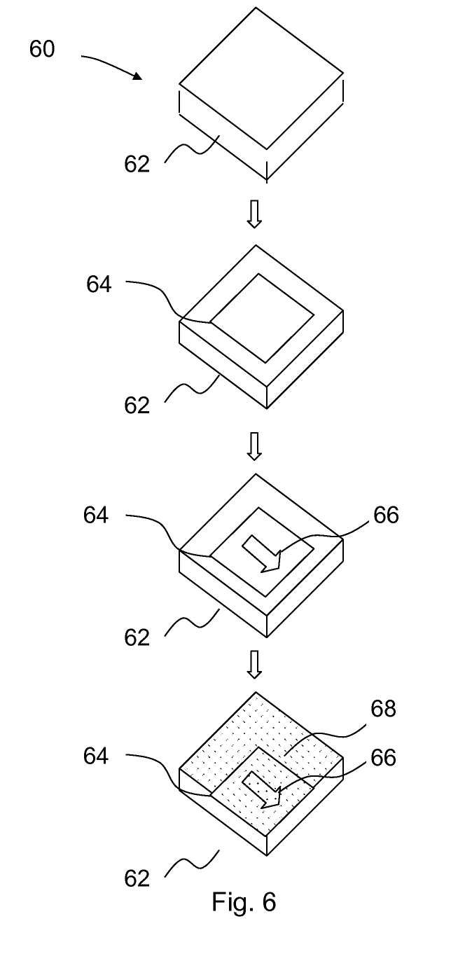

FIGS. 5 and 6 illustrate additional embodiments of the present invention wherein methods of forming composite phosphorescent tile are schematically shown. FIG. 5 depicts a method of forming a composite structured phosphorescent tile 50 according to an embodiment of the present invention including the steps of providing a substrate 52 that takes the form of a tile body, a phosphorescent layer 54 disposed on said substrate 52 and a wear layer 56 disposed on said phosphorescent layer and the step of firing phosphorescent tile 50 at a temperature between 500 C and 1600 C. Substrate 52 is typically a ceramic composition formed by conventional ceramic processing techniques. Phosphorescent layer 54 has a composition that does not contain a frit and is substantially formed of photoluminescent phosphor. Phosphorescent layer 54 may be formed onto the surface of substrate 52 as a layer using conventional ceramic powder processing techniques such a tape casting, slip casting or silk screening. Phosphorescent layer 54 takes the form of a graphic and in particular the form of an arrow to indicate a directional path for someone to follow in the case of emergency signage. Phosphorescent layer 54 may take other forms including schematic designs and words such as “EXIT” to denote an exit location in the case of fire. Wear layer 56 may be a frit containing layer and is intended to provide desirable surface properties for the fired phosphorescent tile 50. These desirable surface properties may include matte, gloss, textured, anti-slip, decorative, colorants and abrasion resistance finishes or combinations thereof. The wear layer 56 may be formed onto the surface of phosphorescent layer 54. Alternatively, phosphorescent layer 54 and wear layer 56 may be formed into sheets separately and then stacked on substrate 52. The layers of phosphorescent tile 50 may then be co-fired in a furnace at a temperature between 500 C and 1600 C in a controlled atmosphere. Some layers may be fired at a temperature between 500 C and 1600 C sequentially prior stacking all the layers for the aforementioned co-firing. For example, the phosphorescent layer 54 may be fired with the substrate 52 at a temperature between 1000 C and 1600 C in a controlled atmosphere prior to the addition of wear layer 56.

FIG. 6 depicts a method of forming a composite structured phosphorescent tile 60 according to an embodiment of the present invention including the steps of providing a substrate 62 that takes the form of a tile body, a reflective layer 64 disposed on substrate 62, a phosphorescent layer 66 disposed on said reflective layer 64 and a wear layer 68 disposed on phosphorescent layer 66 and the step of firing phosphorescent tile 60 at a temperature between 500 C and 1600 C. Substrate 62 is typically a ceramic composition formed by conventional ceramic processing techniques. Reflective layer 64 is designed to reflect light emitted from the phosphorescent layer 66 back through the phosphorescent layer providing a more pronounced and sustained phosphorescent effect. Suitable compositions for the reflective layer are those that reflect the wavelength of emitted light from a particular photoluminescent phosphor and include materials such as alumina (Al₂O₃), titania (TiO₂) and mixtures thereof. Reflective layer 64 may be formed onto the surface of substrate 62 using conventional ceramic powder processing techniques. Phosphorescent layer 66 preferably has a composition that does not contain a frit and the majority of the layer is preferably formed of photoluminescent phosphor. Phosphorescent layer 66 may be formed onto the surface of reflective layer 64 as a layer using conventional ceramic powder processing techniques such a tape casting, slip casting or silk screening. Phosphorescent layer 66 takes the form of a graphic and in particular the form of an arrow to indicate a directional path for someone to follow in the case of emergency signage. Phosphorescent layer 66 may take other forms including schematic designs and words such as “EXIT” to denote an exit location in the case of fire. Wear layer 68 may be a frit containing layer and is intended to provide desirable surface properties for the fired phosphorescent tile 60 and is preferably transparent. These desirable surface properties may include matte, gloss, textured, anti-slip, decorative, colorants and abrasion resistance finishes or combinations thereof. Alternatively, reflective layer 64, phosphorescent layer 66 and wear layer 68 may be formed into sheets separately and then stacked on substrate 62. The layers of phosphorescent tile 60 may then be co-fired in a furnace at a temperature between 500 C and 1600 C in a controlled atmosphere. Some layers may be fired at a temperature between 500 C and 1600 C sequentially prior stacking all the layers for the aforementioned co-firing. For example, the phosphorescent layer 66 may be fired with the substrate 62 and the reflective layer 64 at a temperature between 1000 C and 1600 C in a controlled atmosphere prior to the addition of wear layer 68.

As is apparent, there are numerous modifications of the preferred embodiments described above which will become readily apparent to one skilled in the art, such as many variations and modifications of the inorganic phosphorescent article including many different variations of the photoluminescent phosphors, many variations of methods of phosphorescent article construction and controlled atmospheres. These modifications would be apparent to those having ordinary skill in the art to which this invention relates and are intended to be within the scope of the claims which follow.

That which is claimed is:

1. A phosphorescent article comprising:
a layer consisting essentially of photoluminescent phosphor wherein said layer is sintered at a temperature between 1000 C and 1600 C in a controlled atmosphere.

2. The phosphorescent article according to claim 1 wherein said photoluminescent phosphor comprises a rare earth doped alkaline earth aluminate.

3. The phosphorescent article according to claim 2 wherein said rare earth doped alkaline earth aluminate comprises strontium aluminate.

4. The phosphorescent article according to claim 3 wherein said controlled atmosphere is a reducing atmosphere.

5. The phosphorescent article according to claim 4 wherein said reducing atmosphere comprises hydrogen.

6. The phosphorescent article according to claim 1 wherein said layer takes the form of a graphic design.

7. A photoluminescent article comprising:
a composite body having a substrate and a non-fit containing phosphorescent layer comprising a photoluminescent material bonded to said substrate, wherein said composite body has been fired to a temperature between 500 C and 1600 C.

8. The photoluminescent article according to claim 7 wherein said photoluminescent material comprises a rare earth doped alkaline earth aluminate.

9. The photoluminescent article according to claim 8 wherein said rare earth doped alkaline earth aluminate comprises strontium aluminate.

10. The photoluminescent article according to claim 8 wherein said rare earth doped alkaline earth aluminate comprises calcium aluminate.

11. The photoluminescent article according to claim 7 wherein said photoluminescent material comprises a rare earth doped alkaline earth silicate.

12. The photoluminescent article according to claim 7 wherein said photoluminescent material comprises zinc sulfide doped with copper.

13. The photoluminescent article according to claim 7 wherein said phosphorescent layer takes the form of a graphic design.

14. A photoluminescent article comprising:
a composite body having a substrate, a non-fit containing phosphorescent layer comprising a photoluminescent material bonded to said substrate and a wear layer bonded to said phosphorescent layer,
wherein said composite body has been fired to a temperature between 500 C and 1600 C.

15. The photoluminescent article according to claim 14 wherein said photoluminescent material comprises a rare earth doped alkaline earth aluminate.

16. The photoluminescent article according to claim 15 wherein said rare earth doped alkaline earth aluminate comprises strontium aluminate.

17. The photoluminescent article according to claim 15 wherein said rare earth doped alkaline earth aluminate comprises calcium aluminate.

18. The photoluminescent article according to claim 14 wherein said photoluminescent material comprises a rare earth doped alkaline earth silicate.

19. The photoluminescent article according to claim 14 wherein said photoluminescent material comprises zinc sulfide.

20. The photoluminescent article according to claim 14 wherein said phosphorescent layer takes the form of a graphic design.

21. An inorganic photoluminescent article comprising:
a composite body having a substrate, a reflective layer bonded to said substrate, a phosphorescent layer comprising a photoluminescent material bonded to said reflective layer.

22. The photoluminescent article according to claim 21 wherein said photoluminescent material comprises a rare earth doped alkaline earth aluminate.

23. The photoluminescent article according to claim 22 wherein said rare earth doped alkaline earth aluminate comprises strontium aluminate.

24. The photoluminescent article according to claim 22 wherein said rare earth doped alkaline earth aluminate comprises calcium aluminate.

25. The photoluminescent article according to claim 21 wherein said photoluminescent material comprises a rare earth doped alkaline earth silicate.

26. The photoluminescent article according to claim 21 wherein said photoluminescent material comprises zinc sulfide doped with copper.

27. The photoluminescent article according to claim 21 wherein said phosphorescent layer takes the form of a graphic design.

28. The photoluminescent article according to claim 21 further comprising a wear layer bonded to said phosphorescent layer.

29. The photoluminescent article according to claim 28 further comprising a decorative layer.

30. A method of forming a photoluminescent article comprising:
providing a composite body having a substrate layer and a phosphorescent layer wherein said phosphorescent layer comprises greater than 90% by weight of inorganic photoluminescent phosphor; and
firing said composite body at a temperature between 500 C and 1600 C in a controlled atmosphere.

31. The method according to claim 30 wherein said photoluminescent phosphor comprises a rare earth doped alkaline earth aluminate.

32. The method according to claim 31 wherein said rare earth doped alkaline earth aluminate comprises strontium aluminate.

33. The method according to claim 32 wherein said controlled atmosphere is an inert atmosphere.

34. The method according to claim 32 wherein said controlled atmosphere comprises hydrogen.

35. The method according to claim 30 wherein said providing step includes a wear layer wherein said phosphorescent layer is disposed between said substrate layer and said wear layer.

36. A method of forming a photoluminescent article comprising:
providing a composite body having a substrate layer, a reflective layer disposed on said substrate layer, and a phosphorescent layer disposed on said reflective layer wherein said phosphorescent layer comprises inorganic photoluminescent material; and
firing said composite body at a temperature between 500 C and 1600 C in a controlled atmosphere.

37. The method according to claim 36 wherein said photoluminescent material comprises a rare earth doped alkaline earth aluminate.

38. The method according to claim 37 wherein said rare earth doped alkaline earth aluminate comprises strontium aluminate.

39. The method according to claim 38 wherein said controlled atmosphere is an inert atmosphere.

40. The method according to claim 38 wherein said controlled atmosphere comprises hydrogen.

41. The method according to claim 36 wherein the phosphorescent layer takes the form of graphic design.

42. The method according to claim 36 wherein said providing step includes a wear layer wherein said phosphorescent layer is disposed between said reflective layer and said wear layer.
